(19) United States
(12) Patent Application Publication
(10) Pub. No.: US 2015/0296800 A1
(43) Pub. Date: Oct. 22, 2015

(54) METHOD FOR ELIMINATING BIOFILMS FOR CLEANING MEDICAL INSTRUMENTS, IN PARTICULAR FOR COMBATING NOSOCOMIAL INFECTIONS

(71) Applicant: Realco S.A., Louvain-la-Neuve (BE)

(72) Inventors: Sébastien Fastrez, Mons (BE); Gordon Blackman, Lasne (BE); Camille Gathy, Ceroux-Mousty (BE)

(73) Assignee: Realco S.A., Louvain-la-Neuve (BE)

(21) Appl. No.: 14/646,841

(22) PCT Filed: Nov. 21, 2013
(86) PCT No.: PCT/EP2013/074399

§ 371 Date: May 22, 2015

(30) Foreign Application Priority Data
Nov. 26, 2012 (BE) 2012/0800
Apr. 12, 2013 (BE) 13163533.6

(51) Int. Cl. A01N 63/00

(52) U.S. Cl. CPC A01N 63/00

(57) ABSTRACT

A method for eliminating biofilms for cleaning medical instruments, in particular for combating nosocomial infections, comprising a step of surface treatment for a predefined period of time with a composition comprising at least one detergent component and at least one enzymatic component and a step of rinsing and/or drying said surface.

The present invention relates to a method for eliminating biofilms for cleaning medical instruments, in particular for combating nosocomial infections.

A biofilm is a viscous film which develops on all surfaces, following the adhesion of microorganisms on the surfaces and the secretion by the latter of polymers which cover them and facilitate their adhesion. Biofilms thus form a protective layer around microorganisms and represent a recurrent source of contamination of the surrounding medium which poses major problems in terms of health, for example in hospital environments. Biofilms are found in many environments, for example in water circuits, cooling towers, on all immersed material (boat hull, . . . ) but also on teeth (plaque) or in the intestine and most particularly on medical instruments used in a hospital environment.

The accumulation of polymers secreted by the bacteria (proteins and polysaccharides mainly) generates a matrix which protects these microorganisms from outer aggressions and which has a very strong resistance to conventional cleaning and disinfection procedures. Microorganisms develop therein and contaminate the surrounding medium. Biofilms consequently are a critical source of contamination since they are present everywhere, thus representing a high risk of contamination since they are very difficult to eliminate.

Unfortunately it is observed that this matrix is highly resistant and may form a barrier protecting the bacteria from agents which would act against microorganisms. Conventional treatments based on soda and/or including various biocides do not act in a sufficiently efficient way since they do not penetrate the biofilm in the whole of its thickness or are inhibited by certain molecules making up this matrix. The treatment is then only partly effective on the upper surface of the biofilm.

Now, today, hygiene has become a problem of primary importance in the food industry. Indeed, the problems of contamination are increasing while the means used for disinfections are increasingly powerful. Moreover, this problem should be tackled by an overall approach, notably as regards the resistance phenomenon.

From document WO2012/048757 a composition and a method for eliminating biofilms are known for cleaning floors and surfaces in agri-feed industries. More particularly, the composition disclosed in this document is intended for treatment and for cleaning operations of facilities in the field of the food industry where bacteria specific to this activity segment secrete protective biofilms responsible for a recurrent source of contamination of foodstuffs and/or of facilities of agri-feed industries.

A similar problem is observed in hospital settings where many microorganisms develop, responsible for the formation of biofilms which are detected in many locations, both in the patients (prosthesis, wounds, respiratory system, . . . ) and in the environment (operation room, surgical material, equipment for maintenance of this material, endoscopes, urinary probes, catheters, medical equipment, dialysis or assisted ventilation apparatuses for patients, . . . ) and surfaces (floors, walls, rooms, beds, mattresses, . . . ).

In the field of the food industry, but in an even more consequent way in hospital settings, the problem of the presence of biofilms is double. First, the latter represent a permanent source of contamination and are very difficult to eliminate with conventional means, even the most aggressive. Indeed, conventional disinfectants are inefficient since they do not manage to attain the microorganisms which are protected by the biofilm. Their incomplete elimination causes and accelerates transfers of contamination from patients to patients from the moment that they are practically invisible. However, following impacts or friction, skins of biofilms may detach and release bacteria which were accommodated therein. Indeed, these hidden bacteria are for example released following an impact or friction of a surgical tool on a carriage or following the friction of a bed against a door, which allows free transfer of the bacteria to a patient often in a fragile condition. This problem is one of the causes of problematical nosocomial diseases. In the case of a tool like orthopedic rasps, this problem is even more blatant from the moment that conventional use of the tool causes abrasion and detachment of the skins of biofilms. Therefore the bacteria are directly released into the human body which represents a perfect living incubator for their proliferation. These microorganisms confined in the biofilms, by the resistance and the protection provided to them from the biofilm, therefore represent a high risk of contamination of the following patients.

Secondly, a biofilm is mixed. I.e., developed by certain strains, a biofilm may harbour other strains, which then live and develop in colonies. These colonies promote communication between bacteria and inter alia the exchange of genes. The propagation of the resistance genes borne by certain bacteria is thus facilitated within the biofilms which are then even more difficult to eliminate. On this matter, the hospitals form an environment particularly prone to these gene exchanges since many bacteria live together therein, for example in rooms, in operation rooms but also on medical instruments (orthopedic rasps, reamers, cannulas, endoscopes, . . . ). In biofilms, the problem is still enhanced since these strains are not even reached by the disinfectants, protected by the matrix of the biofilm.

This is why, because of the source of persistent contamination which they represent and because of their widespread presence, it is estimated that biofilms are responsible for 65% of nosocomial diseases (diseases caught in a health institution). Their impact on this highly critical problem in hospital settings is therefore high, in parallel with their participation in the development of resistance phenomena.

Unfortunately, the conventional cleaning and disinfection techniques presently applied in hospital settings show certain limits as to the elimination of the biofilms in order to combat nosocomial diseases. This is mainly related to their inability to attack the matrix of polymers which protects these microorganisms. Indeed, <<conventional>> detergents do not allow detachment of this matrix and powerful oxidants only dissolve it partly. The disinfectants and/or biocides used a posteriori are consequently inefficient since they cannot attain the microorganisms. Further, it was shown that bacteria secrete substances which have an impact on the efficiency of biocides, which limits all the more the action of the latter.

Presently, it is therefore particularly difficult to eliminate the biofilms, however, for a large part, responsible for nosocomial diseases in hospital settings. Therefore there exists a real need for developing a composition and a method for eliminating biofilms from surfaces such as for example from those of medical instruments, particularly for combating nosocomial diseases since the present cleaning techniques are not sufficiently efficient.

The object of the invention is to overcome these drawbacks by providing a method as indicated initially, characterized in that it comprises a step for surface treatment during a predetermined period of time with a composition comprising at least one detergent component and at least one enzymatic component and a step for rinsing and/or drying said surface.

Advantageously, according to the invention, said detergent component comprises a wetting agent or a dispersant.

Preferably, according to the invention, said detergent component further comprises a sequestering agent.

Preferentially, according to the invention, said at least one enzymatic component for example contains at least one protease, at least one laccase and at least one polysaccharidase.

Advantageously, according to the present invention, said wetting agent and said dispersant form a premix and are therefore mixed together.

Within the scope of the present invention, it was shown that such a treatment with such a composition according to the invention allows the enzymes (proteases, laccases, polysaccharidases) to efficiently and degrade and in a versatile way the organic polymers, of various natures forming the matrix of the biofilms formed by a multitude of various microorganisms directly or indirectly responsible for nosocomial diseases. Under the action of enzymes and together with the action of the detergent component, the matrix of the biofilm is made fragile and swollen, which allows its elimination from the treated surface. Moreover, surprisingly, it was also shown that the method according to the invention is not specific to a particular microorganism and therefore to a particular type of biofilm but it is adapted to many bacterial strains, the enzymes acting on the polymers of the matrices of the biofilms formed by any microorganism. The detergent action of the composition according to the invention further gives the possibility of ensuring the efficiency of the composition according to the invention. For this purpose, a detergent base is provided according to the invention which is compatible and which may synergistically act with the enzymatic activity of the enzymatic component. Further, according to the invention, a detergent base is provided which allows significant improvement in the rapidity and efficiency of the elimination of the biofilm. It is for these reasons that the present invention associates a wetting agent and a dispersant and optionally a sequestering agent. The joint actions of these agents of the detergent component of the composition according to the invention allows elimination of the surface portion of the biofilm, wetting and swelling of the organic structures of the biofilm therefore promoting in this way accessibility of the enzymatic component which in turn makes the matrix of the biofilm fragile and degrades it.

In a quite unexpected way, it was determined, within the scope of the present invention that such a treatment efficiently acts on the microorganisms responsible for nosocomial diseases and specifically found in hospital settings. Unexpectedly, it was shown that the treatment according to the invention gives the possibility of obtaining clearly and significantly superior results in terms of elimination of the biofilms as compared with treatment techniques presently applied in hospital settings.

Preferably, in accordance with the method according to the invention, said surface treatment step for combating nosocomial diseases comprises a step for eliminating biofilms, giving the possibility of reducing the microorganisms responsible for nosocomial diseases. Indeed, according to the present invention, it is considered that a logarithmic reduction (or decrease) by at least one log of the microorganisms protected by the biofilms is significant for giving the possibility of combating nosocomial diseases, which corresponds to a reduction percentage of at least 90% of the microorganisms protected by the biofilms.

This logarithmic reduction is calculated by converting the microbial load into log 10,by subtracting the result of the test sample of the control sample (control), i.e. by subtracting the microbial load present in a given environment (for example at the surface of a medical tool or at the surface of a floor) before a surface treatment step according to the invention for the microbial load present in the same environment following a surface treatment step according to the invention.

It is quite understood that any other well known technique to one skilled in the art and allowing determination of the amounts of microorganisms giving rise to the formation of biofilms before and after treatment of a surface may also be used within the scope of the present invention.

Preferably, in accordance with the method according to the invention, said surface treatment step is carried out by soaking for a predetermined period of time comprised between 20 minutes and 24 hours in a soaking solution comprising said composition and an aqueous dilution phase formed beforehand. A treatment by soaking is particularly indicated for cleaning surfaces or medical tools (orthopedic rasps, reamers, cannulas, endoscopes . . . ) from the moment that these surfaces or these tools may be immersed in a container (tank, basin, . . . ) filled with said soaking solution. For example, the medical tools may dwell therein for more or less time, for example a few minutes, a few hours or a few days in the soaking solution without hindering the application of other medical interventions. In the case of endoscopes, said soaking solution may be injected into the pipes of the endoscopes in order to ensure their cleaning.

Advantageously, according to the invention, said step for a surface treatment by soaking is associated with a step for mechanical abrasion of said surface with said soaking solution, for example by mechanized or hand brushing or by treatment with ultrasonic waves. An additional mechanical abrasion step allows the soaking solution comprising said composition in an aqueous phase to act on the different layers of the biofilms but also to mechanically participate in de-structuration of the polymeric matrix and thereby remove skins from the surface of the biofilms so that the enzymes and the other components of said composition attain still better the different layers of the biofilms, which ensures optimum treatment of the surfaces in order to efficiently eliminate the biofilms.

Preferably, according to the method according to the invention, the pH of said soaking solution is adjusted to a pH value comprised between 7 and 8.

Preferably, according to the invention, the method further comprises a subsequent additional step for treating said surface with a biocide. An additional disinfecting biocidal treatment, following the action of the enzymatic solution during the surface treatment step by soaking, gives the possibility of ensuring destruction of the released bacteria at the end of the treatment of said surface.

Optionally, this step for treatment by means of a biocidal agent may be followed by a sterilization step, for example by passing into the autoclave.

Other embodiments of the method according to the invention are indicated in the appended claims.

The present invention also deals with a novel use of a composition comprising at least one detergent component and at least one enzymatic component for combating nosocomial diseases by eliminating biofilms. By eliminating biofilms by soaking in the diluted composition, it is possible to efficiently combat nosocomial diseases since the enzymatic components of the aqueous soaking solution allow de-structuration and elimination of the biofilms from the treated surfaces so that the biofilms, for a large part responsible for nosocomial diseases, are eliminated. This action of the enzymes is favoured by the fact that it occurs in synergy with the action of the detergent component of the composition according to the invention, which allows elimination of the surface portion of the biofilm, wetting and swelling of the organic structures of the biofilm and thereby promoting accessibility of the enzymatic component which in turn makes the matrix of the biofilm fragile and degrades it.

Preferably, according to the invention, said detergent component of the composition used comprises a wetting agent and a dispersant.

Advantageously, according to the invention, said detergent component of the composition used further comprises a sequestering agent.

Preferably, according to the invention, said enzymatic component of the composition used for example contains at least one protease, at least one laccase and at least one polysaccharidase.

More particularly, the present invention deals with a use of a composition comprising at least one detergent component comprising a wetting agent and a dispersant and optionally a sequestering agent, and at least one enzymatic component containing at least one protease, at least one laccase and at least one polysaccharidase, for eliminating sources of contamination comprising Staphylococcus aureus and/or Escherichia coli and/or Pseudomonas aeruginosa. These bacteria develop particularly well in hospital settings and are responsible for many infections. As an example, Staphylococcus aureus, found in 15 to 30% of healthy individuals, is highly resistant and is consequently very rapidly transmitted from one patient to the other not only by direct transmission via the caregivers but also by indirect transmission via objects (medical tools, . . . ) and even dust. With bacilli, Staphylococcus aureus is considered as being the main bacterium responsible for hospital infections and its dissemination for a large part responsible for nosocomial diseases causing death of a patient should therefore be controlled.

The invention also deals with a use of a composition comprising at least one detergent component and at least one enzymatic component, for treating surfaces, of medical tools or floors in order to combat nosocomial diseases by soaking.

Preferably, said detergent component of said composition used comprises a wetting agent and a dispersant.

Advantageously, said detergent component of said composition used further comprises a sequestering agent.

Preferentially, said enzymatic component of said composition used for example contains at least one protease, at least one laccase and at least one polysaccharidase.

Other embodiments for the use of a composition by soaking according to the invention are indicated in the appended claims.

The detergent component comprising a wetting agent and a dispersant and optionally a sequestering agent first of all acts by eliminating a surface portion of the biofilm and by wetting and/or by swelling the organic structures of the biofilm.

The detergent component therefore favors accessibility of the enzymatic component by de-structuring the matrix of the biofilm. The enzymatic component then acts synergistically with the detergent component and in turn makes the matrix of the biofilm fragile and degrades it. This combined action of the three types of enzyme and of the detergent component, perfectly compatible with a proper action of the enzymes, favors accessibility to the composition of the deeper layers and allows rapid and optimum detachment of any type of biofilm while preserving the substrate. Such a composition according to the invention further reduces the provision of external compounds in facilities during the cleaning step and therefore simplifies the procedures for validating cleaning steps. Thus, the detergent component allows the enzymes to rapidly act on the whole of the structures of the biofilms, which, in hospital settings where tools, rooms and operation rooms have to be able to be reused very rapidly following an intervention, represents a certain advantage.

The dispersant of the detergent component allows improvement in the separation of the particles of a suspension in order to prevent agglutination, aggregation and/or decantation. Said dispersant may be a polymer either soluble or partly soluble in water such as for example polyethylene glycol, derivatives of cellulose or a polymer comprising at least one acrylic acid or acrylic ester unit. Preferentially, the dispersant is a polymer comprising at least one acrylic acid or acrylic ester unit of general formula —(CH₂—CH—COOR)— wherein R represents a hydrogen, an alkyl or substituted alkyl, an aryl or substituted aryl. In particular, the dispersant is a polymer having an average molecular weight Mw approximately comprised between 500 and 10,000.

More preferentially, the dispersant agent is a polymer of acrylic acid. In particular, the dispersant agent may be a homopolymer of acrylic acid having an average molecular weight approximately comprised between 2,000 and 6,000.

In an advantageous alternative according to the invention, the detergent component comprises a proportion of dispersant comprised between 1 and 10% by weight based on the total weight of the detergent component.

More particularly, according to the present invention, said dispersant of said detergent component is a C₆ alkylglucoside.

The presence of a dispersant agent in the composition according to the invention for eliminating biofilms and combating nosocomial diseases gives the possibility of avoiding any aggregation of bacterial particles upon cleaning surfaces, which ensures optimum elimination of the biofilm particles detached from a support under the action of enzymes. Indeed, rather than aggregate, these particles remain separated in a suspension, do not redeposit and do not adhere again on the cleaned support.

The wetting agent of the detergent component is an amphiphilic chemical substance, or a composition comprising said amphiphilic chemical substance, which modifies the surface tension between two surfaces. The wetting agent has the advantage of promoting the spreading of a liquid on a solid but also enhancing the contact between two surfaces. More particularly, the wetting agent promotes contact between the detergent component and a surface and therefore between the enzymes and their substrate. Now, in hospital settings, the surfaces to be treated are often in stainless steel or in a material on which application of a liquid gives rise to the formation of droplets. This characteristic of the surfaces to be treated makes it difficult to homogeneously apply a composition in liquid form for combating the presence of biofilms. This is why the wetting agent is a particularly advantageous constituent of said composition according to the invention since it allows, even on the surfaces of the stainless steel type, homogenous spreading of the composition and thus its perfect distribution over the surfaces to be decontaminated, for example on surgical tools and on floors.

The wetting agent may be anionic, cationic, non-ionic or zwitterionic. Preferentially, the wetting agent may be an anionic or non-ionic wetting agent, i.e. the hydrophilic portion is negatively charged and does not include any net charge or may be a composition comprising an anionic wetting agent. More particularly, the wetting agent may be a saccharose ester or a composition comprising a sodium alkylsulfate and an alcohol.

Advantageously, and preferably, in the detergent component according to the invention, said wetting agent is non-foaming under hot conditions and is preferably selected from the group of sodium C₆-C₁₀ alkyl sulfates, etherated C₆-C₁₀ alcohol sulfates and C₆-C₁₀ alkylaryl sulfonates.

More particularly, according to the present invention, said wetting agent of said detergent component is ethoxylated 2-ethylhexanol.

By the fact that the wetting agent is non-foaming under hot conditions, it is possible to use the composition according to the invention for treating medical tools having pipes, such as for example endoscopes. Indeed, the wetting agent being non-foaming, this gives the possibility of avoiding formation of foam, without altering, quite on the contrary, the surfactant and/or emulsifying performances of the composition according to the invention. It is quite understood that providing an efficient detergent solution without generating any foam limits the rinsing steps, which is particularly desirable, especially for medical tools having pipes which may thus be reused rapidly for a new intervention.

In an embodiment according to the invention, the detergent component comprises a proportion of wetting agent comprised between 1 and 15% by weight based on the total weight of the detergent component.

The sequestering agent is a chemical substance having the capability of forming complexes with mineral ions which it binds in a form preventing their precipitation by the usual reactions. As an example, the sequestering agent may be ethylene-diamine-tetraacetic acid, glucono-delta-lactone, sodium gluconate, potassium gluconate, calcium gluconate, citric acid, phosphoric acid, tartaric acid, sodium acetate, sorbitol, a compound including a phosphorus atom. Preferentially, the sequestering agent may be a phosphorus oxide such as a phosphonate, a phosphonate or a phosphate or their mixture, or a salt of the latter, an amine or an amine oxide bearing at least in its structure a phosphine, phosphine oxide, phosphinite, phosphonite, phosphite, phosphonate, phosphonate or phosphate functional group, either alone or as a combination, or a salt thereof.

Advantageously, the sequestering agent is a chemical substance compatible with substances which may be used in hospitals, for example, the sequestering agent is preferentially a non-toxic agent for human health.

More preferentially, the sequestering agent may be a phosphonate or a salt of the latter, an amine or an amine oxide including at least, in its structure, a phosphine, phosphine oxide, phosphinite, phosphonite, phosphite, phosphonate, phosphinate or phosphate functional group, either alone or as a combination, or a salt thereof. As a non-limiting example, the phosphonate may be of the general formula R¹(R²O)(R³O)P═O wherein R¹, R² and R³ represent independently a hydrogen, an alkyl, a substituted alkyl, an alkyl-amino either substituted or not, an aminoalkyl either substituted or not, an aryl or substituted aryl. As a non-limiting example, the amine or the amine oxide may include one, two or three substituent(s) of general formula CR⁴R⁵W wherein R⁴ and R⁵ represent independently of each other a hydrogen, an alkyl, a substituted alkyl, an alkyl-amino either substituted or not, an aminoalkyl either substituted or not, an aryl or substituted aryl, and W represents a phosphonate, phosphinate or phosphate group.

The sequestering agent may be in the form of a sodium, calcium, lithium, magnesium or potassium salt; preferentially, the sequestering agent may be in the form a sodium, calcium or potassium salt.

Preferably, the sequestering agent is an agent which may be used without any risk during medical interventions, i.e. the sequestering agent has no risk for health, alone or as an association with other components used in medical environments.

More particularly, according to the invention, said sequestering agent of said detergent component is a potassium salt based on modified phosphonic acid (ATMP N-oxide).

In an advantageous embodiment according to the invention, said at least one detergent component comprises a proportion of sequestering agent comprised between 1 and 10% by weight based on the total weight of the detergent component, which represents an optimum between efficiency, stability and cost.

Preferably, said at least one enzymatic component comprises a proportion of protease(s) comprised between 10 to 50%, a proportion of laccase(s) comprised between 5 and 35% and a proportion of polysaccharidase(s) comprised between 5 and 20% by weight based on the total weight of the enzymatic component, the 100% of the enzymatic component being optionally reached by means of a conventional excipient or solvent, for example an alcohol.

The enzymatic component according to the invention has the advantage of being versatile, i.e. it may act simultaneously on various bacterial strains, which is particularly advantageous in hospital settings where many different bacterial strains develop simultaneously.

According to a preferred embodiment of the invention, the enzymatic component may contain between 1 and 10 proteases, preferentially between 1 and 5 proteases, more preferentially it may contain 2, 3, 4 or 5 proteases.

Non-limiting examples of protease enzymes belonging to the class EC 3.4 and which may be used in the invention are amino-peptidases (EC 3.4.11), dipeptidases (EC 3.4.13), dipeptidyl-peptidases and tripeptidyl-peptidases (EC 3.4.14), peptidyl-dipeptidases (EC 3.4.15), serine carboxypeptidases (EC 3.4.16), metallo-carboxypeptidases (EC 3.4.17), cysteine carboxypeptidases (EC 3.4.18), omega peptidases (EC 3.4.19), serine endopeptidases (EC 3.4.21), cysteine endopeptidases (EC 3.4.22), aspartic endopeptidases (EC 3.4.23), metallo-endopeptidases (EC 3.4.24), threonine endopeptidases (EC 3.4.25), and endopeptidases belonging to the class EC 3.4.99.

Preferentially, the proteases belong to the class EC 3.4.21. The proteases are commercially available and in various forms including powders, granules, suspensions, liquid solutions.

The laccases used in the invention belong to the class EC 1.10.3.2. The laccases are enzymes containing copper and have the function of oxidizing a substrate in the presence of oxygen. More specifically, the laccases are oxidoreductases which operate with molecular oxygen as an electron acceptor.

Said at least one polysaccharidase used in the invention is an enzyme having the function of breaking bonds within polysaccharides. Preferentially, said at least one polysaccharidase may be an alpha-amylase, cellulase, hemi-cellulase, glucosidase, beta-glucanase or pectinase.

More preferentially, said at least one polysaccharidase may be an alpha-amylase belonging to the class EC 3.2.1.1, having the function of breaking (1-4)-alpha-glycoside bonds in polysaccharides containing three units or more of alpha-(1-4)-D-glucose.

Preferentially, the enzymatic component may comprise a proportion of laccase(s) of approximately 30%, a proportion of protease(s) of approximately 30%, a proportion of alpha-amylase(s) of approximately 10% by weight based on the total weight of the enzymatic component, the 100% of the enzymatic component being possibly attained by means of a conventional excipient or solvent.

According to another preferred embodiment, if the enzymatic component comprises two proteases, the proportion of laccase(s) may be approximately 30%, the total proportion of proteases of approximately 30%, the proportion of alpha-amylase(s) of approximately 10% by weight based on the total weight of the enzymatic component, the 100% of the enzymatic component being possibly attained by means of a conventional excipient or solvent.

For example, the ratio between each protease may be comprised between 1:2 and 2:1, preferentially the ratio between each protease may be 1:1. The enzymes present in the enzymatic component have a complementary action on the biofilm. For example, the laccase has great efficiency on filth not attacked by alpha-amylase or proteases. As mentioned above, the enzymatic component, because of the simultaneous presence of at least three types of enzymes, is versatile and may act at the same time on various types of biofilms produced by various bacterial strains, which is essential in hospital settings.

According to a preferred embodiment of the invention, the enzymatic component may be a solution or in a solid form.

Preferentially, the enzymatic component is a solution for which the pH may be comprised approximately between 8 and 10. Preferentially, the enzymatic component is an aqueous solution for which the pH may be comprised approximately between 8.5 and 9.5; more preferentially, the pH may be approximately 9.0, and this for at most preserving the integrity of the enzymes.

Alternatively, the enzymatic component may be in solid form such as for example in the form of a lyophilisate, powders, granules or in any other form allowing solubilization of said component in a solvent, and then it will be subsequently dissolved in said solvent. The solvent may be water or an aqueous, acid, basic, alcoholic, buffered or neutral solution. The solubilized enzymatic component may then in this case be subsequently diluted in an aqueous solution optionally containing one or several compounds such as for example detergents for forming the cleaning solution.

Like for the enzymatic component, the detergent component may be in a solid form to be dissolved in a solvent and/or in an aqueous phase or in liquid form.

When it is in solid form, it may either be put directly into solution, in the solution formed by the enzymatic component optionally already diluted in the aqueous phase, or either be put in solution in a solvent, before its dilution in the solution formed by the enzymatic component and aqueous phase, or directly in the aqueous phase, before dilution of the enzymatic component.

When the detergent component is in liquid form, the 100% of the detergent component is possibly attained generally with water and before application on the biofilm, it will be diluted in an aqueous phase, possibly already containing the enzymatic component.

Optionally, according to the method of the present invention, the pH of said solution is adjusted to a pH value comprised between 6.5 and 7.5, more particularly about 7.

Alternatively, said composition may be in solid form and be then dissolved before use in a solvent in order to obtain, when it will be diluted in an aqueous phase before application on a biofilm, a solution for which the pH is approximately comprised between 7 and 8. In an advantageous alternative according to the invention, the composition is a solution intended for, when it is diluted in an aqueous phase before application of the biofilm, forming a solution having a pH approximately comprised between 6.5 and 7.5, more particularly about 7. In this way, the pH of the solution of the composition is particularly suitable for the action of the enzymatic component, in particular of the laccase.

Alternatively, said composition may be in solid form and then be dissolved before use in a solvent in order to obtain a solution which will then be diluted in an aqueous phase in order to obtain a cleaning solution for which the pH is approximately comprised between 6.5 and 7.5, preferably about 7.

According to the method of the present invention, the entirety of the matrix of biofilms is eliminated, the surface treatment according to the invention only leaving <<naked>> bacteria, i.e. bacteria without any protection and which may thus be easily eliminated in totality upon subsequent use of a biocide, as explained hereafter after rinsing the composition.

As mentioned above, the composition according to the invention comprises a detergent component which promotes action of the enzymes by giving them the possibility of rapidly attaining the lower layers of the biofilms and not only their upper layer. The enzymes may then act very rapidly on the whole of the structure of the biofilms and thus expose all the bacteria not only at the surface of the biofilms but also at the lower layers which make them up.

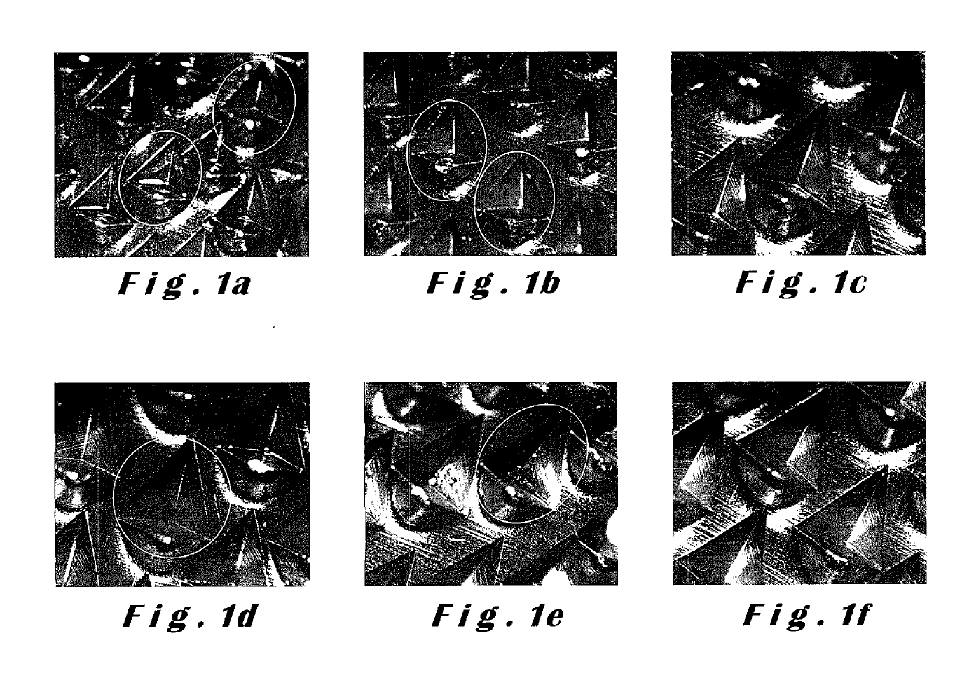

FIGS. 1a to 1f illustrate the obtained colorations (the surrounded areas are areas having a blue coloration) during the use of a kit for detecting the presence of a biofilm in order to evaluate the efficiency of the cleaning techniques on rasps with narrow pores after pre-cleaning (1a), after cleaning in a solution of Aniosyme® (1b), and after cleaning in a soaking solution according to the invention (1c) but also for rasps with wide pores after pre-cleaning (1d), after cleaning in a solution of Aniosyme® (1e) and after cleaning in a soaking solution according to the invention (1f).

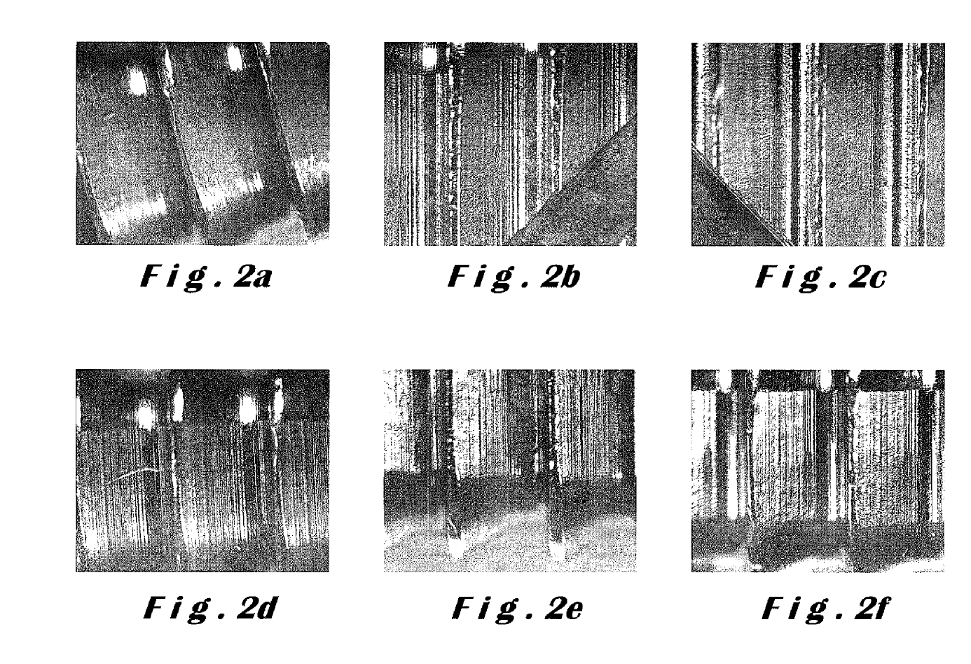

FIGS. 2a to 2f illustrate the obtained colorations (the surrounded areas are areas having a blue coloration) during the use of a kit according to the patent EP 2537601 for detecting the presence of biofilm in order to evaluate the efficiency of the cleaning techniques on rasps after pre-cleaning (2a), after cleaning in a soaking solution according to the invention (2b), after cleaning in an inventive soaking and brushing solution (2c), after cleaning in a solution of Aniosyme® (2d), after cleaning in a solution of Aniosyme® and brushing (2e) and after cleaning in a solution of Aniosyme® and brushing and then cleaning in a soaking solution according to the invention and brushing (2f).

### EXAMPLES

### Example 1

### Cleaning of Medical Instruments by Soaking in a Soaking Solution According to the Invention—ATP-Metric Analyses

Tests were conducted in order to determine whether the method according to the invention allows efficient elimination of biofilms present on medical instruments by soaking in an aqueous soaking solution according to the invention.

This aqueous soaking solution was prepared by diluting a first product comprising a detergent component comprising a sequestering agent, a wetting agent and a dispersant and of a second product comprising an enzymatic component comprising at least one protease, at least one laccase and at least one polysaccharidase, in distribution water at 45° C. so that the aqueous soaking solution comprises a concentration of 0.25% (v/v) of said first product and a concentration of 0.1% (v/v) of said second product.

Before soaking the instruments in the soaking solution, the latter were washed with the washer-disinfector so as to be ready for use according to the procedures and application standards in hospitals.

ATP-metric analyses, in order to measure the presence of adenosine triphosphate were conducted in order to determine:
the amount of ATP molecules on the surface of the medical instruments before cleaning with the aqueous soaking solution according to the invention,
the amount of ATP molecules in the aqueous soaking solution directly following immersion of the medical instruments (i.e. before cleaning by soaking, strictly speaking) in the aqueous soaking solution, and
the amount of ATP molecules in the aqueous soaking solution after 30 minutes of soaking of the medical instruments in the aqueous soaking solution.

The amount of ATP molecules at the surface of the medical instruments was determined by swabbing the surface of the instruments before applying the analysis procedure of the ATP testing method proposed by 3M™ (3M Clean-Trace). This analysis technique gives the possibility of measuring a produced amount of light (URL) which is directly proportional to the amount of biological energy present in the analyzed solution, i.e. to the amount (concentration) of microorganisms in the analyzed solution. The measurement of the amount of emitted light therefore gives the possibility of detecting and quantifying the presence of ATP molecules and therefore determining the amount (concentration) of microorganisms in the analyzed solution (since ATP is an essential molecule for microbial life). Therefore, this analysis technique allows the determination of the extent that the aqueous soaking solution according to the invention allows elimination of the biofilms in order to allow access to microorganisms, the amount of which is measured by ATP-metry.

The obtained results were interpreted on the basis of the following Table 1 and are shown in Table 2.

TABLE 1

| Amount of produced | |
|---|---|
| light (URL) | Interpretation |
| <500 URL | No required action: few bacteria |
| >500 URL and | Action to be taken if there is a high |
| <999 URL | risk area: bacteria present |
| >1,000 URL | Action to be undertaken: many bacteria present |

TABLE 2

| | ATP on the | ATP in solution | ATP in solution |
|---|---|---|---|
| | surface | in the aqueous | in the aqueous |
| | before | soaking solution | soaking solution |
| | cleaning | following immer- | after cleaning |
| | (URL) | sion (URL). | by soaking (URL) |
| Suction cannula | 309 | Not measured | Not measured |
| for coelioscopy | | | |
| Reamer | 1,576 | 14 | 185 |
| Orthopedic rasp | 235 | Not measured | Not measured |
| for hips | | | |
| Orthopedic rasp | 7 | Not measured | Not measured |
| for hips: the | | | |
| open hole | | | |
| Column cannula | Not measured | Not measured | Not measured |
| ENT cannula | Not measured | Not measured | Not measured |

The ATP-metric analyses allowed determination of a large amount of biofilms (ATP molecules) for the reamer before cleaning by soaking (1,576 URL) while low fouling levels (contamination by the presence of biofilms) were noted for the other medical instruments which consequently are not subject to cleaning by soaking in the aqueous soaking solution according to the invention. The results obtained with the reamer give the possibility of noticing that the ATP level measured directly after immersion of the reamer in the soaking solution is very low (14 URL) but this level significantly increases after 30 minutes of soaking in the soaking solution. This clearly indicates that soaking in the soaking solution according to the invention gives the possibility of detaching the biofilms from the surface of the medical instruments, in this case the reamer in the present case, which gives the possibility of accessing the microorganisms.

### Example 2

### Comparative Cleaning Tests of Medical Instruments by Soaking in a Soaking Solution According to the Invention and by Autoclaving—Analyses by Use of a Detection Kit

Comparative tests were conducted in order to compare in terms of elimination of biofilms, cleaning carried out by soaking for 30 minutes in an aqueous soaking solution according to the invention (as described in Example 1) with cleaning carried out by autoclaving at 134° C. for 90 minutes (a technique presently applied in hospital settings).

Before these two types of cleaning, the medical instruments were first pre-cleaned in a cleaner-disinfector so as to be ready to use according to the procedures and application standards in hospitals.

In order to measure the efficiency of each of these cleaning operations, a detection kit was used on the surfaces of the medical instruments in order to detect the presence or the absence of biofilms:
before cleaning,
before cleaning by soaking in an aqueous soaking solution according to the invention, and
after cleaning by passing into the autoclave.

The detection kit consists of two products, a coloration reagent and a cleaning reagent. The blue coloring agent present in the coloration reagent specifically adheres to the EPSes (extracellular polymeric substances) forming the protective matrix of the biofilm. The surface to be analyzed is sprayed with the coloration solution. After 5 minutes of action on the surface, the excess of the solution is absorbed. Next the surface is rinsed with the cleaning solution which requires an application time of 5 minutes. The surface is finally rinsed with water and is analyzed. The presence or absence of biofilm is demonstrated by a more or less dark blue color according to the amount of existing biofilm on the surface. Intense blue coloration indicates a significant presence of biofilm.

The obtained results, in terms of coloration at the surface of the analyzed instruments, are shown in Table 3 below for the tested medical instruments.

TABLE 3

| | | After soaking | |
|---|---|---|---|
| | After pre- | in the soaking | |
| | cleaning with | solution | After |
| | the cleaner- | according to | auto- |
| | disinfector | the invention | claving |
| Reamer | Intense blue | Absence of blue | Average blue |
| | coloration | coloration | coloration |
| Suction cannula | Intense blue | Absence of blue | Not measured |
| for coelioscopy | coloration | coloration | |
| Orthopedic rasp | Intense blue | Absence of blue | Average blue |
| | coloration | coloration | coloration |
| ENT cannula | Intense blue | Slight blue | Not measured |
| | coloration | coloration | |

From these tests, it emerges that the pre-cleaned instruments by passing them in a cleaner-disinfector all include biofilms (intense blue coloration) and therefore this present cleaning technique applied in hospitals leaves biofilms on the medical instruments. On the other hand, these results clearly indicate that soaking in an aqueous soaking solution according to the invention allows very significant elimination of the biofilms at the surface of the medical instruments, which autoclaving does not allow since a blue coloration is always noted following this type of cleaning.

### Example 3

### Comparative Cleaning Tests of Medical Instruments by Soaking in a Soaking Solution According to the Invention, by Soaking in an Aqueous Solution of Aniosyme® and by Autoclaving—ATP-Metric Analyses

Comparative tests were conducted in order to compare, in terms of elimination of biofilms, a cleaning operation carried out by soaking for 30 minutes in an aqueous solution according to the invention (as described and prepared in Example 1), with a cleaning operation carried out by soaking for 15 minutes in an aqueous solution of Aniosyme® (a solution claiming elimination of the biofilms) at 0.5% prepared according to the prescriptions of the manufacturer with a cleaning operation carried out by autoclaving at 134° C. for 90 minutes.

Before these three types of cleaning, the medical instruments were first pre-cleaned in a cleaner-disinfector so as to be ready for use according to the procedures and application standards in hospitals.

Following soakings either in an aqueous solution according to the invention, or in an aqueous solution of Aniosyme® according to the prescriptions of the manufacturer, the medical instruments were rinsed with clean water ad then autoclaved.

ATP-metric analyses, according to the analyses procedure of the ATP testing method proposed by 3M™ (3M Clean-Trace), were carried out for measuring:
the amount of ATP molecules at the surface of the medical instruments before cleaning,
the amount of ATP molecules at the surface of the medical instruments after 30 minutes of soaking in the soaking solution according to the invention and after autoclaving,
the amount of ATP molecules at the surface of the medical instruments after 15 minutes of soaking in the aqueous solution of Aniosyme® and after autoclaving, and
the amount of ATP molecules at the surface of the medical instruments after autoclaving at 134° C. for 90 minutes.

The obtained results were interpreted according to the criteria mentioned in Table 1 and are shown in Table 4 below.

TABLE 4

| | | ATP after | ATP after | |
|---|---|---|---|---|
| | | soaking in the | soaking in a | |
| | ATP after pre- | soaking solution | solution of | |
| | cleaning with | according to | Aniosyme ® | ATP after |
| | the cleaner- | the invention | and auto- | auto- |
| | disinfector | and auto- | claving | claving |
| | (URL) | claving (URL) | (URL) | (URL) |
| Reamer | 14 | Not measured | Not measured | Not measured |
| Cannula 1 | 418.5 | Not measured | 15 | Not measured |
| Cannula 2 | 476.5 | Not measured | Not measured | Not measured |
| Cannula 3 | | Not measured | Not measured | 10 |
| Rasp | 14 | Not measured | Not measured | Not measured |
| Straight clamp | 231 | Not measured | Not measured | Not measured |
| with wide teeth | | | | |
| Clamp with | 437 | Not measured | Not measured | Not measured |
| sloped teeth | | | | |
| Cannula 2 | 522 | Not measured | Not measured | Not measured |
| (outer) | | | | |
| Wide ENT | 569.5 | 12 | Not measured | Not measured |
| cannula | | | | |
| Thin ENT | 400 | Not measured | 32 | Not measured |
| cannula | | | | |
| Suction | 2,487.5 | 9 | Not measured | Not measured |
| cannula for | | | | |
| coelioscopy | | | | |

A very high ATP value (2,487.5 URL) is observed for the suction cannula for coelioscopy before the cleaning operations. This indicates a large amount of residual biofilms after pre-cleaning in a cleaner-disinfector and therefore that the instruments supposed to be ready for use include nevertheless further biofilms protecting microorganisms potentially responsible for nosocomial diseases.

On the other hand, after soaking in the soaking solution according to the invention, the ATP level (or the amount of ATP molecules) moves down to a very low level (9 URL) indicating a high cleanliness level, corresponding to a logarithmic reduction of 1.6 Log of the microorganisms protected by the biofilms and responsible for nosocomial diseases, i.e. at a reduction percentage of more than 90% of the microorganisms protected by the biofilms. Similar results are obtained for the wide ENT cannula for which a logarithmic reduction of 2.44 Log is noted, which corresponds to a reduction percentage of more than 90% of the microorganisms protected by the biofilms. The other analysed instruments have low to average ATP values before the cleaning operations and therefore have not been subject to cleaning with the soaking solution according to the invention.

### Example 4

### Comparative Cleaning Tests of Medical Instruments by Soaking in a Soaking Solution According to the Invention and by Soaking in an Aqueous Solution of Aniosyme®-Analyses by Using a Detection Kit

Comparative tests were conducted in order to compare, in terms of elimination of biofilms, a cleaning operation carried out by soaking for 30 minutes in an aqueous solution according to the invention (as described and prepared in Example 1), with a clean operation carried out by soaking for 15 minutes in an aqueous solution of Aniosyme® (a solution claiming elimination of biofilms) at 0.5% prepared according to the prescriptions of the manufacturer.

Before both of these types of cleaning, the medical instruments were first pre-cleaned in a cleaner-disinfector so as to be ready for use according to the procedures and application standards in hospitals.

Rinsing with clean water of the instruments was carried out following the cleaning operations by soaking.

In order to measure the efficiency of each of these cleaning operations, a detection kit as described in Example 2 was used on the surfaces of the medical instruments:
before cleaning,
after cleaning by soaking for 30 minutes in a soaking solution according to the invention, and
after cleaning by soaking for 15 minutes in a soaking solution of Aniosyme® according to the prescriptions of the manufacturer.

The presence or the absence of biofilm is demonstrated by a more or less dark blue color depending on the amount of existing biofilm on the surface. An intense blue coloration indicates a significant presence of biofilm.

The obtained results are shown in Table 5 below for the medical instruments tested.

TABLE 5

| | After pre- | After soaking | |
|---|---|---|---|
| | cleaning | in the soaking | |
| | with the | solution | After soaking |
| | cleaner-dis- | according to | in a solution |
| | infector | the invention | of Aniosyme ® |
| Orthopedic rasp | Intense blue | Slight blue | Intense blue |
| with narrow pores | coloration | coloration | coloration |
| | (FIG. 1a) | (FIG. 1c) | (FIG. 1b) |
| Orthopedic rasp | Intense blue | Slight blue | Intense blue |
| with wide pores | coloration | coloration | coloration |
| | (FIG. 1d) | (FIG. 1f) | (FIG. 1e) |
| Orthodontic clamp | Intense blue | Slight blue | Intense blue |
| | coloration | coloration | coloration |
| Suction cannula | Intense blue | Slight blue | Intense blue |
| for coelioscopy | coloration | coloration | coloration |
| ENT cannula (wide | Intense blue | Slight blue | Intense blue |
| endpiece) | coloration | coloration | coloration |

From these tests, and as illustrated in FIGS. 1a to 1f, it emerges that the pre-cleaned instruments by passing in a cleaner-disinfector include all biofilms (intense blue coloration) and therefore that this present cleaning technique for application in hospitals leave biofilms on the medical instruments. On the other hand, these results clearly indicate that soaking in an aqueous soaking solution according to the invention gives the possibility of very significantly removing the biofilms at the surface of medical instruments, which soaking in an aqueous solution of Aniosyme® does only allow to a lesser extent.

### Example 5

### Comparative Cleaning Tests of Medical Instruments (Rasps) by Soaking in a Soaking Solution According to the Invention and by Soaking in an Aqueous Solution of Aniosyme® Associated with a Hand Brushing Step—Analyses by Using a Detection Kit

Comparative Tests were conducted for comparing, in terms of elimination of biofilms, a cleaning operation carried out by soaking for 30 minutes in an aqueous soaking solution according to the invention (as described in Example 1) and associated with a hand brushing step, with a cleaning operation carried out by soaking for 15 minutes in an aqueous solution of Aniosyme® (a solution claiming elimination of biofilms) at 0.5% prepared according to the prescriptions of the manufacturer and associated with a hand brushing step.

Before both of these types of cleaning, the medical instruments (rasps) were first pre-cleaned in a cleaner-disinfector so as to be ready for use according to the procedures and application standards in hospitals.

In order to measure the efficiency of each of these cleaning operations, a detection kit as described in Example 2 was used on the surfaces of the rasps:
before cleaning,
after cleaning by soaking for 30 minutes in a soaking solution according to the invention,
after cleaning by soaking for 30 minutes in a soaking solution according to the invention and manual brushing,
after cleaning by soaking for 15 minutes in a soaking solution of Aniosyme® according to the prescriptions of the manufacturer,
after cleaning by soaking for 15 minutes in a soaking solution of Aniosyme® according to the prescriptions of the manufacturer and manual brushing, and
after a first cleaning operation by soaking for 15 minutes in a soaking solution of Aniosyme® according to the prescriptions of the manufacturer and manual brushing followed by a second cleaning operation by soaking in a soaking solution according to the invention and manual brushing.

The obtained results are shown in Table 6 below.

The presence or the absence of a biofilm is demonstrated by a more or less dark blue color depending on the amount of existing biofilm on the surface. An intense blue coloration indicates a significant presence of biofilm.

TABLE 6

| | | (b) | | (d) | | |
|---|---|---|---|---|---|---|
| | | After | | After | | |
| | | soaking | | soaking in | | |
| | (a) | according | (c) | a solution | (e) | |
| | After pre- | to the | (b) + | of | (d) + | (f) |
| | cleaning | invention | brushing | Aniosyme ® | brushing | (c) + (e) |
| Rasps | Average | Slight blue | No | Average | Average | No |
| with wide | blue | coloration | coloration | blue | blue | coloration |
| pores | coloration | | | coloration | coloration | |
| Rasps | Intense | Slight blue | No | Intense | Average | No |
| with | blue | coloration | coloration | blue | blue | coloration |
| nanopores | coloration | (FIG. 2b) | (FIG. 2c) | coloration | coloration | (FIG. 2f) |
| | (FIG. 2a) | | | (FIG. 2d) | (FIG. 2e) | |

These results as well as FIGS. 2a to 2f show that a pre-cleaning operation assume to provide rasps ready for use leave biofilms (average to intense coloration depending on the size of the pores of the rasps).

Moreover, from these tests it emerges that cleaning by soaking in an aqueous solution of Aniosyme® does not either allow elimination of the whole biofilm present (average to intense coloration) even when manual brushing is carried out (average coloration).

Moreover, soaking in a soaking solution according to the invention allows significant elimination of the biofilms since a slight blue coloration is observed subsequently to this cleaning.

Moreover, if the soaking in a soaking solution according to the invention is associated with a manual brushing step, the cleaning operation according to the invention allows total elimination of the biofilms from the surface of the rasps. The same observation may only be established if cleaning with a solution of Aniosyme® associated with manual brushing is followed by cleaning by soaking in a solution according to the invention associated with manual brushing.

The fact that without the manual brushing step, the soaking in a soaking solution according to the invention leaves a slight blue coloration is explained by the action of the soaking solution which de-structures the biofilm but, however, without totally detaching it from the surfaces. This is why a manual brushing step is particularly recommended.

### Example 6

### Cleaning of Endoscopes with a Soaking Solution According to the Invention

Cleaned but not declassified endoscopes (not used for several years) and non-sterilized were used for determining the efficiency of the soaking solution according to the invention for cleaning endoscopes.

A first step consisted of carrying out blanking of the endoscopes in a endoscope-washer according to a protocol and procedure known with the commercial solutions Soluscope E (enzymatic solution) at 0.5% and Soluscope D (disinfecting solution based on glutaraldehyde) according to the prescriptions of the manufacturer.

A second step dealt with blanking of the endoscope-washer with a solution according to the invention (as described in Example 1) by following the washing program intended for this purpose by the manufacturer (30 minute cycle: disinfection—rinsing—disinfection—emptying—rinsing—drying).

A third step dealt with cleaning the endoscopes in the endoscope washer with a solution according to the invention (as described in Example 1) and with a commercial disinfectant solution (Soluscope D) following both previous steps. This cleaning in the endoscope washer consists in a 35 minute cycle comprising the following sequential steps: seal test—pre-cleaning—cleaning—rinsing—disinfection—rinsing—drying.

(a) Analyses of the Presence of Biofilm Following the First Step

Following blanking of the endoscopes by standard cleaning in an endoscope-washer, the following analyses were conducted:
bacteriological analysis of the inside of the biopsy cannula of the endoscope by swabbing with an endoscope brush then immersed in peptone water until analysis in the laboratory by spreading it out on a non-selective culture medium and by Bart Test measurements according to the recommendations of the manufacturer.
These analyses of the blanked endoscope gave the possibility of showing that the standard cleaning with the endoscope-washer does not give rise of development of microorganisms on culture media. However, the Bart Tests reacted positively, which however indicates the presence of live microorganisms and therefore of bacteria which may form biofilms.
bacteriological analyses of the endoscope washer (discharge grid, discharge neck, filter) by swabbing, the obtained swabs being kept in peptone water until analysis in the laboratory by spreading it out on a non-selective culture medium, by ATP-metric analysis (as described in the previous examples) and by Bart Test measurements.
Counts of bacteria which develop on Petri dishes allowed demonstration of a strong presence of microorganisms at the discharge neck of the endoscope washer (red color colonies) as well as at the discharge grid (golden yellow colony) and at the filter (red colony). ATP-metric analyses as for them revealed a small presence of microorganisms on these same areas of the endoscope washer (URL values of less than 500)
Replanting of colonies developing on the non-selected culture medium onto specific media (Petrifilm Staph Express 3M) gave the possibility of determining whether these colonies are formed by Staphylococcus aureus.
The Bart Test measurements reacted positively for the samples taken at the discharge grid and at the filter of the endoscope washer.
Therefore it emerges from these analyses that both the blanked endoscopes and the endoscope washer used for obtaining this blanking according to present procedures always include microorganisms which may form biofilm and therefore that these procedures are not optimum.

b) Analyses of the Presence of Biofilm Following the Second Step

Following the blanking of the endoscope-washer with a soaking solution according to the invention, bacteriological analysis of the rinsing water of the endoscope washer was conducted by spreading it out on a culture medium and by Bart Test measurements.

Bacterial colonies were counted on the non-selective culture medium (28 CFU/150 μl) and then re-transplanted on a selected medium for the growth of staphylococci, which gave the possibility of establishing the presence of Staphylococcus aureus in rinsing waters of the endoscope-washer subsequently to washing with the soaking solution according to the invention. The Bart Test measurements confirmed this presence of bacteria in the rinsing waters of the endoscope washer.

These tests give the possibility of drawing the conclusion that the soaking solution according to the invention ensures detachment of the bacteria in the endoscope washer, which gives the possibility of ensuring subsequently better cleaning of the endoscopes, the endoscope washer no longer forming a source of contamination.

c) Analyses of the Presence of Biofilm Following the Third Step

Subsequently to cleaning with the soaking solution according to the invention, endoscopes blanked beforehand (according to the first step) in an endoscope washer blanked beforehand (according to the second step) and disinfected (Soluscope D), bacteriological analyses of the rinsing water of the endoscope-washer and of the endoscopes were conducted by spreading on a culture medium and by Bart Test measurements.

Bacterial colonies were counted in the rinsing water subsequently to the cleaning of the endoscopes with the solution according to the invention (red colonies, 32 CFU/150 μl). The bacteria forming these colonies were identified as being Staphylococcus aureus. The Bart Test measurements also indicate the presence of bacteria in the rinsed water.

This indicates that the soaking solution according to the invention gives the possibility of detaching bacteria still present in the endoscopes and/or in the endoscope-washer even when they have been blanked beforehand.

Analysis of the endoscopes, by swabbing and the spreading of swabs obtained on Petri dishes, did not allow demonstration of the presence of bacteria. On the other hand, the Bart Test measurements reveal the presence of bacteria at the endoscopes even after washing with the soaking solution according to the invention.

It is quite understood that the present invention is by no means limited to the embodiments described above and many modifications may be brought thereto without departing from the scope of the appended claims.

1. A method for eliminating biofilms for cleaning medical instruments, in particular for combating nosocomial diseases, comprising:
a surface treatment step applied on a biofilm on a medical instrument for a pre-determined period of time with a composition comprising at least one detergent component and at least one enzymatic component; and
a rinsing and/or drying step for said surface.

2. The elimination method according to claim 1, said detergent component comprising a wetting agent and a dispersant.

3. The elimination method according to claim 1, said detergent component further comprising a sequestering agent.

4. The method according to claim 1, said at least one enzymatic component containing at least one protease, at least one laccase and at least one polysaccharidase.

5. The method according to claim 1, wherein said surface treatment step for combating nosocomial diseases comprises a step for eliminating biofilms giving the possibility of producing a logarithmic reduction by at least one Log of the microorganisms responsible for nosocomial diseases.

6. The method according to claim 1, wherein said surface treatment step is carried out by soaking for a predetermined period of time comprised between 20 minutes and 24 hours in a soaking solution comprising said composition and an aqueous dilution phase formed beforehand.

7. The method according to claim 6, wherein said surface treatment step by soaking is associated with a step for mechanical abrasion of said surface with said soaking solution.

8. The method according to claim 1, further comprising an additional step for treating said surface with a biocide.

9. A method for combating a nosocomial disease, comprising:
applying a composition comprising at least one detergent component and at least one enzymatic component, to a biofilm; and
eliminating the biofilm to combat the nosocomial disease.

10. The method according to claim 9, said detergent component comprising a wetting agent and a dispersant.

11. The method according to claim 9, said detergent component further comprising a sequestering agent.

12. The method according to claim 9, said enzymatic component containing at least one protease, at least one laccase and at least one polysaccharidase.

13. The method according to claim 9, wherein the biofilm includes at least one of Staphylococcus aureus, Escherichia coli, or Pseudomonas aeruginosa.

14. The method according to claim 9, comprising treating surfaces of medical tools or floors by soaking.

15-17. (canceled)

18. The method according to claim 7, wherein the mechanical abrasion includes mechanized or manual brushing or treatment with ultrasonic waves.
